(19) United States
(12) Patent Application Publication
(10) Pub. No.: US 2010/0259026 A1
(43) Pub. Date: Oct. 14, 2010

(54) Motorcycle having torsion-acting shock absorption

(76) Inventors: Steven J. Patmont, Gardnerville, NV (US); Gabriel S. Patmont, Gardnerville, NV (US)

Correspondence Address: JOHN W. CROSBY, 1650 HIGHWAY 395, MINDEN, NV, 89423, US

(21) Appl. No.: 12/386,268

(22) Filed: Apr. 14, 2009

(51) Int. Cl. B60G 11/23

(52) U.S. Cl. 280/124.169

(57) ABSTRACT

A motorcycle for supporting a seated rider straddling a saddle atop a frame and above a motor has an improved torsion acting shock absorbing mount for the cantilevered shock absorbing support of at least one of the motorcycle wheels from the frame. In a preferred embodiment, the torsion acting shock absorber includes a square sectioned metal tube, a correspondingly square sectioned metal shaft, and confined compressible rubber rods acting there between. A shock absorbing suspension is disclosed for both the front steered wheel and the rear driven wheel.

### FIELD OF THE INVENTION

This invention relates to motorcycles. More particularly, this invention relates to a motorcycle frame having torsion shock absorbers from which cantilevered wheels can be mounted and from which shock absorbing movement of one part of the frame relative to another part of the frame occurs.

### BACKGROUND OF THE INVENTION

Motorcycles have been in use for more than 100 years. Typically, a motorcycle frame suspends the steerable wheel in front of the frame through the use of a fork that retains the wheel between two arms. For shock absorption, the arms of the fork traditionally have incorporated compressible hydraulic shocks inline with the arms. However, traditional forks suffer significant shortcomings. When a brake is applied to the front wheel on a motorcycle, the shocks compress and the front end of the motorcycle dives, causing an unsafe condition for the rider. There is a binding effect because of the torque experienced on the fork when the brake is applied, and, over time, this binding effect creates leaks in the hydraulic seals of the shock absorbers. Hydaulic fluid can subsequently contaminate the brake pads, thus reducing braking efficiency, and again causing an unsafe condition for the rider. Because traditional hydraulic shock absorbers generate heat as the result of telescopic stiction in their normal operation, this also contributes to leaks and eventual failure of the shock absorbers.

Torsion acting shock absorbers are known. In Henschen U.S. Pat. Nos. 5,277,450 and 5,411,287, there is disclosed a torsion axle for use as a shock absorber with trailers. Specifically, square sectioned torsion shafts, square sectioned metal tubes and a plurality of resilient rubber rods acting between the square sectioned torsion shafts and metal tubes are utilized. The resilient rubber rods are confined between the square sectioned metal tubes and the square sectioned metal shafts so as to be compressed by the square sectioned metal shaft when the square sectioned metal shaft rotates relatively to the square sectioned metal tubes. The resilient rubber rods come under compression and torsionally resist rotation of the square sectioned shafts. In a typical application, the metal tubes are attached to the trailer. The torsion shafts are attached to the wheels by an eccentric crank, which eccentric crank is off center with respect to a line extending vertically from the axis of rotation of the wheel vertically upward normal to the trailer. The crank extends outwardly and away from the metal tubes so that the wheels are supported outwardly and away from both the torsion axle and the trailer. When the trailer encounters shock inducing bumps along its path of travel, shock absorbing movement of the crank mounted wheel occurs.

Another problem experienced with traditional motorcycle designs is a result of having a forked arm on each side of the front wheel. In motorcycle designs having a combustion engine, the engine generates significant amounts of heat and incorporates a cooling system, either by air or by fluid. In either case, the flow of air is obstructed by the forked arms onto either the engine itself in air-cooled designs or a front-mounted radiator in fluid-cooled designs. Similarly, the presence of two forked arms also creates aerodynamic drag on the motorcycle.

Finally, removal of the front wheel is complicated by the presence of dual forked arms, and in many designs the wheel is secured independently to each forked arm, thus adding to the weight of the motorcycle as well as the time required to change out a wheel.

Thus, there is a heart-felt need for an improved motorcycle that has better braking and handling characteristics, lighter weight, and simplified shock absorption and suspension.

### BRIEF SUMMARY OF THE INVENTION

The present invention solves the problems described above by providing a motorcycle having a frame, a seat and at least one cantilevered wheel support, the cantilevered wheel support including a torsion acting shock absorber and providing connection to the frame. The cantilevered wheel support is attached to the steerable front wheel, or the rear drive wheel. The cantilevered wheel support includes an upper member and a lower member. The upper member and lower member are attached to a torsion acting shock absorber disposed between the upper member and lower member. In an embodiment, the upper member includes a fluid reservoir capable of storing coolant, fuel, or lubricant.

The cantilevered wheel support, when attached to the steerable front wheel, provides improved handling and braking characteristics as it resists diving of the front end of the motorcycle during braking, as torque from the front wheel works against force that otherwise would drive down the front end of the motorcycle. The cantilevered wheel support also improves safety and dynamic stability of a motorcycle by preventing shortening the wheelbase that would otherwise occur in traditional designs that incorporate telescoping shocks in the front wheel suspension. As front end dive is greatly reduced or eliminated, the wheelbase of the motorcycle is preserved.

In an embodiment, the motor is connected to the rear wheel by a roller chain or a belt, and the motor is mounted on a cantilevered wheel support extending from the torsion-acting shock absorber and tension of the chain or belt between the motor and rear wheel at a constant tension as the cantilevered wheel support moves. By maintaining a constant tension, wear on the roller chain or drive belt is greatly reduced.

In an embodiment, the frame includes a subframe extending from the frame and supporting the seat, and a torsion-acting shock absorber is disposed between the frame and the subframe to provide shock absorption to the seat, thus protecting the rider from shock.

The present invention reduces cost of manufacturing by having a simplified design, reduces friction-generated heat experienced in conventional forks, improves airflow over the motor, and reduces aerodynamic drag by using a singular wheel support for each wheel instead of a dual-support design. Similarly, as suspended weight is significantly reduced, the present invention provides improved handling over uneven terrain.

Many other features and advantages of the present invention will be realized from reading the following detailed description, when considered in conjunction with the drawings, in which:

### BRIEF DESCRIPTION OF THE DRAWINGS

FIGS. 1 and 2 are side elevations of a motorcycle constructed in accordance with this invention illustrating an embodiment in which both the front steered wheel and the rear driven wheel are provided with the torsional shock absorber for the cantilevered mount of the motorcycle wheels;

FIG. 3 is a cross-section of the torsional shock absorbers with compressible members inserted therein in singular configurations;

FIG. 4 is a cross-section of the torsional shock absorbers with compressible members inserted therein in multiple, contiguous configurations;

FIG. 5 is a cross-section of the torsional shock absorbers with solid-filled compressible material placed therein instead of compressible members;

FIG. 6 is an exploded view of the torsional shock absorbers having adjustment mechanisms for adjusting the elasticity of the compressible members or compressible material inserted therein; and

FIG. 7 is a perspective view of the motorcycle of the present invention having the adjustment mechanisms shown in FIG. 6.

### DETAILED DESCRIPTION OF THE INVENTION

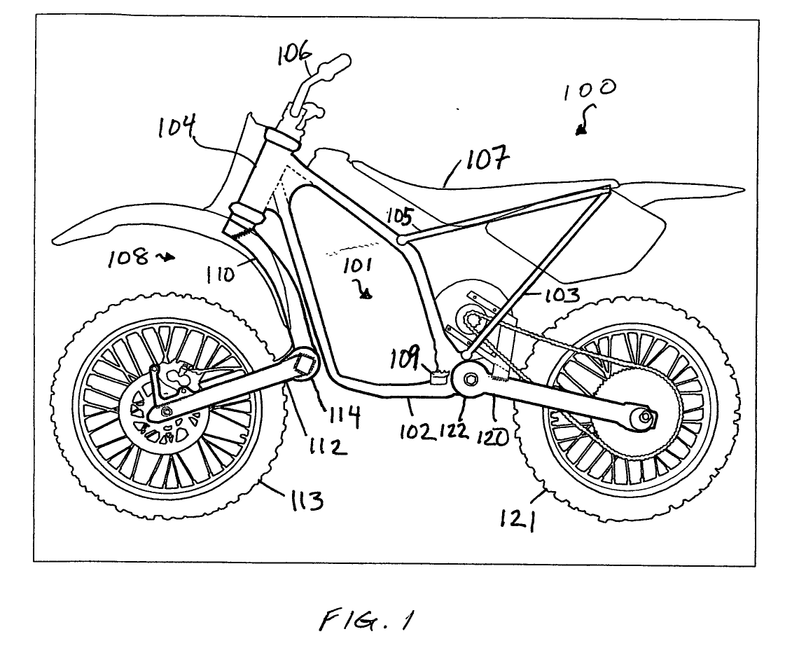

Referring to FIG. 1, motorcycle 100 is shown having frame 102 defining space 101, subframe members 103, 105, gooseneck 104, handlebar set 106, saddle 107, footpeg 109, cantilevered steering arm 108 having upper member 110, lower member 112, first torsion shock absorber 114, steerable front wheel 113, trailing arm 120 connected to frame 102 by second torsion shock absorber 122 and supporting rear driven wheel 121. Simply stated, a rider sits on saddle 107, straddling motorcycle 100, with feet placed on footpegs 109 located on both sides of motorcycle 100, and manipulates handlebar set 106 to steer front wheel 1 13, while controlling throttle and braking functions located on handlebar set 106.

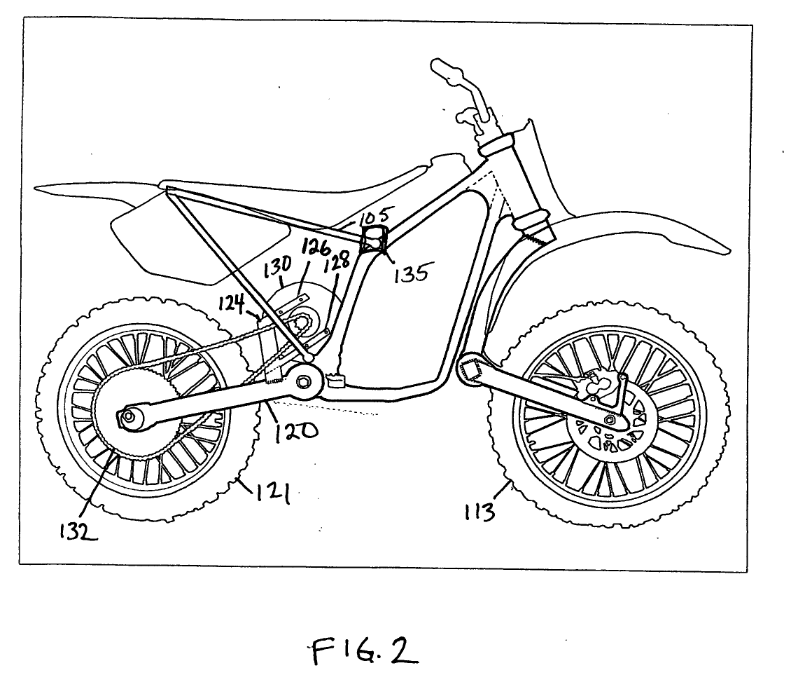

Having set forth the main structural elements of the present invention in FIG. 1, attention can be devoted to trailing arm 120 as illustrated in FIG. 2 which conveniently illustrates the difference between the suspension system applied to the front steered wheel 113 and the rear driven wheel 121. Attached to trailing arm is main mounting arm 124, which extends upwardly from trailing arm 120 and incorporates mounting arms 126, 128, which attach to motor 130, which drives rear wheel 121 via roller chain 132. In an embodiment, roller chain 132 is replaced by a drive belt. By mounting motor 130 on trailing arm 120, the tension of roller chain 132 on wheel 121 is maintained at a constant tension. The motorcycle of the present invention takes advantage of reduced frame weight by eliminating forks and shocks. By drastically reducing weight, in addition to improved handling, an electric motor utilizing is used in the preferred embodiment, but conventional gas motors may also be used in various embodiments.

The present invention, as the result of changed geometry of front wheel 113, is, in an embodiment, outfitted with a radio-controlled braking system wherein there is no cable from the handlebars down to steerable front wheel 113. This allows bar spins to be performed, where a rider spins handlebars 106 to rotate steerable front wheel about the axis defined by gooseneck 104. Furthermore, in another embodiment that allows bar spins, a conventional cable-based braking system is utilized, with the cable passing through lower member 112, first torsion shock absorber 114, upper member 110, gooseneck 104 before connecting to a handbrake on handlebars 106. In an embodiment, a stop is welded to outside of frame 102 to prevent front steerable wheel 113 to be spun in the manner described above.

In an embodiment, lower member 112 and/or trailing arm 120 incorporates a reservoir tank that may used to store fuel, lubricant, or coolant. Lower member 112 and/or trailing arm 120 may also incorporate a battery that can be used to power various accessories on motorcycle 100 or serve as an auxiliary power source in other applications.

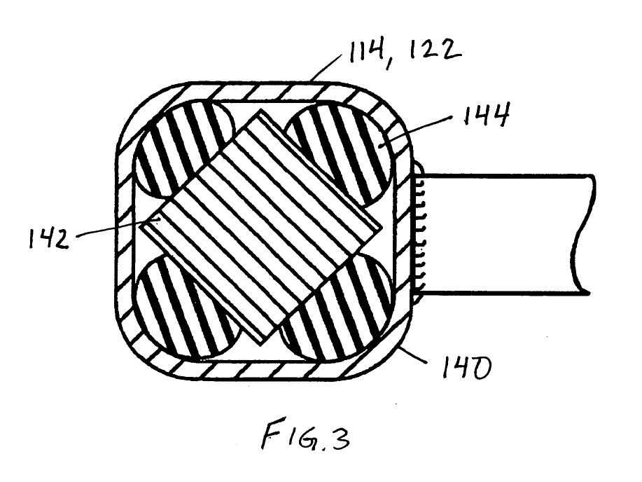

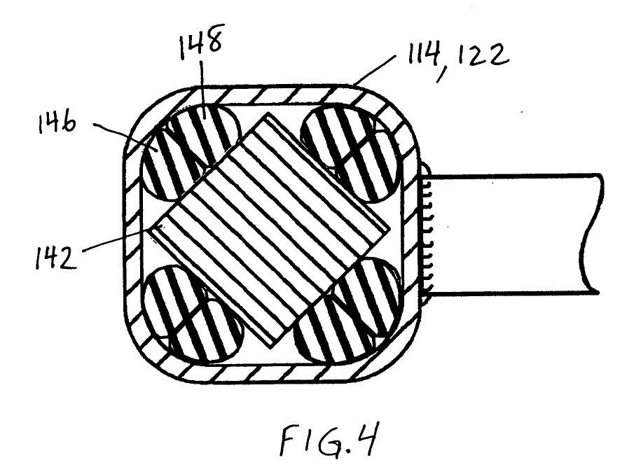

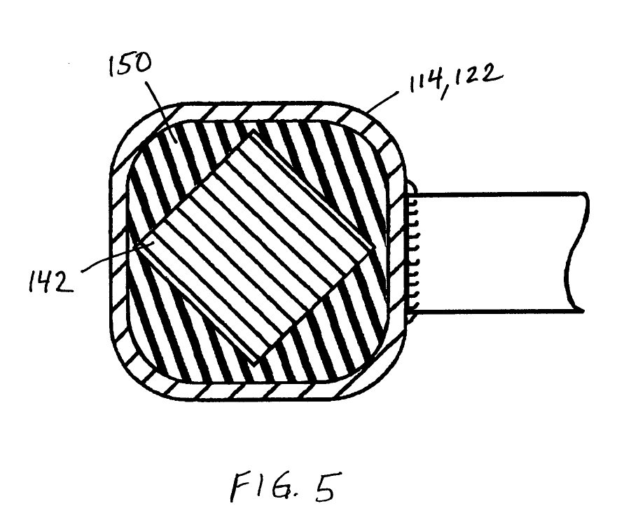

Torsion shock absorbers 114, 122 contribute greatly to the handling improvement and weight reduction of motorcycle 100. Directing attention to FIG. 3, torsion shock absorbers 114, 122 contain square tube 140. Tube 140 houses square section shaft 142 extending centrally therein. Compressible members 144 are trapped between the respective sides of square section shaft 140. Rotation of shaft 142 compresses compressible members 144 with resultant shock absorption. Compressible members 144 can be placed separately, or, as shown in FIG. 4, multiple compressible members 146, 148 can be placed together. Alternatively, as shown in FIG. 5, compressible material 150 can fill the space surrounding square section shaft 142 within tube 140. Compressible members 144, 146 and compressible material can be made from elastic materials such as rubber, polymers, and the like. The elasticity can be varied, depending on application and rider preference. Also, torsion shock absorber 135 (FIG. 2), similar to torsion shock absorbers 114, 122 can also be used in an embodiment on frame 102 where subframe member 105 connects to frame 102 to absorb shocks otherwise delivered to a seated rider.

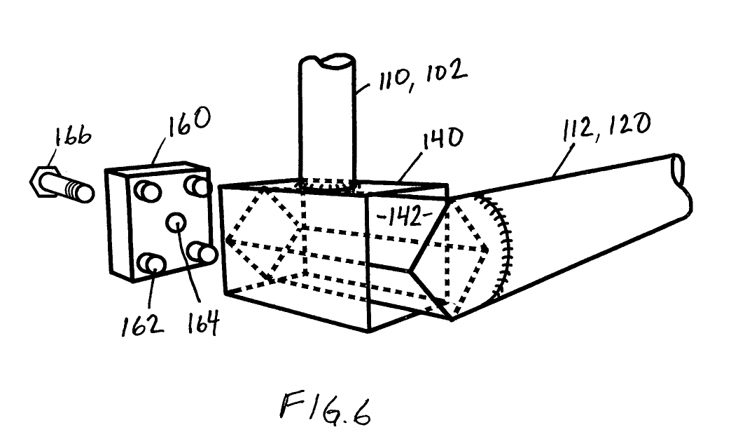

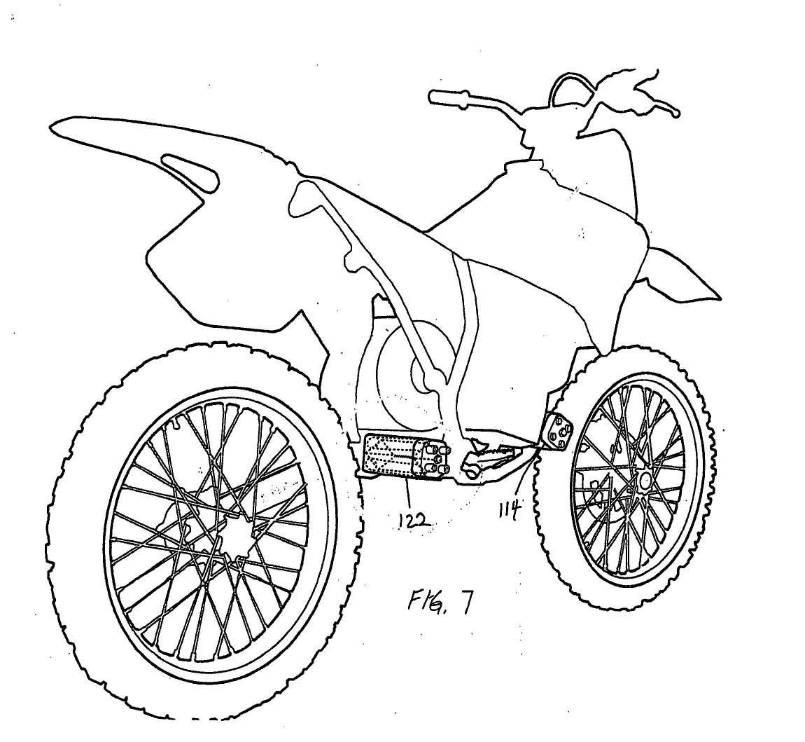

FIG. 6 illustrates an embodiment of torsion shock absorbers 114, 122 having individual adjustments for compressible members 144, 146 and compressible material 150. In an embodiment, cap 160 attaches to square section shaft 142 by bolt 166. Bolt 166 threads through cap 160 and into a threaded bore inside square section shaft 142. Individual set screws 162 are located on portions of cap 160 that oppose compressible members 144, 146, or portions of compressible material 150. By adjusting set screws 162, set screws 162 are driven against compressible members 144, 146 and compressible material 150, providing increased firmness, thus adjusting handling of motorcycle 100 by changing shock absorption characteristics. FIG. 7 illustrates motorcycle 100 with shock absorbers 114, 122 having adjustable set screws.

Shock absorbers of the type illustrated in FIGS. 3-6 are readily available on a commercial basis. For example, such shock absorbers may be purchased from QDS Henschen Inc. of Jackson Center, Ohio. Having described the preferred embodiment of the present invention, it is to be understood that numerous changes and modifications can be made to the present invention without departing from the spirit thereof.

What is claimed is:

1. A motorcycle, comprising:
a frame, the frame having a plurality of elongated members joined end-to-end to define a space such that the space is disposed between a first wheel and a second wheel aligned in the direction of travel;
a seat for supporting a seated rider straddling the frame above a motor, the saddle attached to the top of the frame; and
at least one cantilevered wheel support, the cantilevered wheel support including a torsion acting shock absorber and providing connection to the frame.

2. The motorcycle of claim 1, wherein the cantilevered wheel support is attached to a steerable wheel.

3. The motorcycle of claim 1, wherein the cantilevered wheel support includes an upper member and a lower member, the upper member and lower member attached to a torsion acting shock absorber disposed between the upper member and lower member.

4. The motorcycle of claim 4, wherein the upper member includes a fluid reservoir, the fluid reservoir containing at least one of the group consisting of coolant, fuel, and lubricant.

5. The motorcycle of claim 1, wherein cantilevered wheel support is attached to a rear wheel, the rear wheel driven by a motor mounted to the cantilevered wheel support.

6. The motorcycle of claim 5, wherein the motor is connected to the rear wheel by a roller chain, the roller chain having a constant tension as the cantilevered wheel support moves.

7. The motorcycle of claim 5, wherein the motor is connected to the rear wheel by a belt, the belt having a constant tension as the cantilevered wheel support moves.

8. A motorcycle, the motorcycle comprising:
a frame, the frame having a plurality of elongated members joined end-to-end to define a space;
a saddle for supporting a seated rider straddling the frame, the saddle attached to the top of the frame;
a steerable wheel supported by a singular cantilevered wheel support, the cantilevered wheel support including a torsion acting shock absorber.

9. The motorcycle of claim 8, wherein the torsion acting shock absorber includes a square-sectioned shaft disposed within a square-sectioned tube, and confined compressible rods acting there between by resisting rotation of the square-sectioned shaft within the square-sectioned tube.

10. The motorcycle of claim 8, wherein multiple compressible rods are disposed in pairs between said square-sectioned tube and square-sectioned shaft.

11. The motorcycle of claim 8, wherein the square-sectioned shaft is surrounded by compressible material within the square-sectioned tube.

12. A motorcycle, the motorcycle comprising:
a frame, the frame having a plurality of elongated members joined end-to-end to define a space;
a seat for supporting a seated rider straddling the frame, the seat attached to the top of the frame;
a rear driven wheel supported by a singular cantilevered wheel support, the cantilevered wheel support including a torsion acting shock absorber.

13. The motorcycle of claim 12, wherein the torsion-acting shock absorber includes a square-sectioned metal tube, a correspondingly square-sectioned metal shaft, and confined compressible rods acting there between by resisting rotation of the square-sectioned shaft within the square-sectioned tube.

14. The motorcycle of claim 12, wherein multiple compressible rods are disposed in pairs between said square-sectioned tube and square-sectioned shaft.

15. The motorcycle of claim 12, wherein the square-sectioned shaft is surrounded by compressible material within the square-sectioned tube.

16. The motorcycle of claim 12, wherein cantilevered wheel support is attached to a rear wheel, the rear wheel driven by a motor mounted to the cantilevered wheel support.

17. The motorcycle of claim 12, wherein the motor is connected to the rear wheel by a roller chain, the roller chain having a constant tension as the cantilevered wheel support moves.

18. The motorcycle of claim 12, wherein the motor is connected to the rear wheel by a belt, the belt having a constant tension during operation of the torsion-acting shock absorber.
